(19) United States
(12) Patent Application Publication
(10) Pub. No.: US 2013/0298702 A1
(43) Pub. Date: Nov. 14, 2013

(54) IN SITU MARINE SAMPLE COLLECTION SYSTEM AND METHODS

(71) Applicant: Woods Hole Oceanographic Institution, Woods Hole, MA (US)

(72) Inventors: Phoebe J. Lam, Falmouth, MA (US); Paul J. Morris, Poole (GB)

(21) Appl. No.: 13/864,655

(22) Filed: Apr. 17, 2013

Related U.S. Application Data
(60) Provisional application No. 61/625,334, filed on Apr. 17, 2012.

(51) Int. Cl. G01N 1/14

(52) U.S. Cl. CPC G01N 1/14
USPC 73/863.23

(57) ABSTRACT

According to one aspect, the invention relates to a marine sample collection system adapted for in situ use. The system includes a first filter head and a second filter head for filtering material of interest from ambient marine fluid passing therethrough and a respective filter flow meter disposed downstream of each of the filter heads for measuring volumetric flow through each filter head. The system also includes a pump downstream of the filter heads for inducing flow through the filter heads and an outlet flow meter disposed downstream of the pump for measuring volumetric flow through the pump. An optional controller compares a sum of an output of the flow meters associated with the first and second filter heads and an output of the outlet flow meter to determine if there is leakage in the system.

### RELATED APPLICATIONS

This application claims priority to and the benefit of U.S. Provisional Patent Application Ser. No. 61/625,334 filed on Apr. 17, 2012, the disclosure of which is hereby incorporated herein by reference in its entirety.

### FIELD OF THE INVENTION

The present invention relates generally to in situ systems for collecting marine samples and, more specifically, to systems having multiple inlets for collecting multiple samples simultaneously.

### BACKGROUND OF THE INVENTION

Quantification and analysis of suspended marine particles are key to understanding the processes that govern the large-scale distributions of key trace elements and isotopes in the ocean. Samples may be collected in-situ using pumps adapted to process and filter large volumes (up to thousands of liters of marine fluids, such as seawater). In-situ pump and filtration systems include the Multiple Unit Large Volume in-situ Filtration System (MULVFS) by Ocean Biogeochemical Processes Group (Berkeley, Calif.), a ship-powered system. Commercially-available battery-operated systems include the Stand-Alone Pump System (SAPS), which was previously available from Challenger Oceanic, located in the UK, and Water Transfer System—Large Volume (WTS-LV), a battery-operated system, manufactured by McLane Research Laboratories, Inc. (East Falmouth, Mass.).

These and other types of systems are lowered overboard on a tether and, at a predetermined depth, turned on to pump seawater through a filter to capture radionuclides, trace metals, organic material, etc., depending on filter type. These tethered systems can typically only be deployed to limited depths (e.g., approximately 1 km or 2 km), much less than the depths from which samples are often desired. Battery powered systems, such as the SAPS and WTS-LV identified above, may provide for sampling at greater depths, but must be retrieved and a new filter installed to obtain sampling at a different depth or to use a filter of a different type. Tracking of the amount of seawater pumped through the filter is critical to gaining an accurate assessment of concentration of the filtered sample.

Accordingly, there is a need to provide a multi-filter, remotely controlled system for sampling different elements at the same depth or the same or different elements at different depths. There is also a need to ensure accurate volumetric flow measurements through the filters to maintain confidence in calculated results.

### SUMMARY OF THE INVENTION

The present invention relates to systems and methods for filtering particles in situ through the use of multiple flow paths with separate filter heads, allowing sampling for multiple users from a single sampling event. This mode of sample collection generates a single, synchronous sample that is ideal for cross-comparison and data synthesis, and also saves on ship time for collecting measurements. The systems and methods may be further augmented through the use of filter holders designed to improve the collection and retention of large particle samples.

According to one aspect, the invention relates to a marine sample collection system adapted for in situ use. The system includes a first filter head and a second filter head for filtering material of interest from ambient marine fluid passing therethrough and a respective filter flow meter disposed downstream of each of the filter heads for measuring volumetric flow through each filter head, after which the two flow streams are joined into one flow stream. The system also includes a pump downstream of the filter heads for inducing flow through the filter heads and an outlet flow meter disposed downstream of the pump for measuring volumetric flow through the pump.

In accordance with one embodiment of the above aspect, at least one of the filter heads may include a subassembly adapted to be removed from the system without disassembly. The subassembly may include a top plate having a plurality of baffle tubes, a base plate, and fasteners for releasably coupling the top plate to the base plate to install and remove a filter therebetween. In certain embodiments, the base plate includes a perforated element and/or a porous frit element to support the filter. The subassembly may include at least one baffle plate disposed between the top plate and the base plate above the filter. The baffle plate may include a grate. In still other embodiments, the subassembly may include a seal for sealing a flow path formed by the top plate and the base plate. The seal may include at least one O ring. The subassembly may include a perforated film covering open ends of the baffle tubes. The perforated film may be held in place with an adhesive (e.g., electrical tape).

In additional embodiments, the filter heads may be arranged in parallel flow paths. The first filter flow meter may measure volumetric flow through solely the first filter head and a second filter flow meter may measure volumetric flow through solely the second filter head. The combined volumetric flows through the first filter head and the second filter head may pass through the pump and the outlet flow meter. The system may include flow meter displays and optionally a controller for comparing respective outputs of the first filter flow meter, the second filter flow meter, and the outlet flow meter to assess leakage in the system. The sum of the first filter flow meter output and the second filter flow meter output may be substantially equivalent to the outlet flow meter output to indicate insubstantial leakage in the system. The filter heads may be adapted to filter at least one of organic material and trace metals.

In other embodiments, the system includes a material for scavenging dissolved radionuclides. The scavenging material may be MnO₂ and/or CuFeCN. The radionuclides may be Ra isotopes, Th isotopes, Ac isotopes and/or Cs isotopes. The scavenging material may be located downstream of the filter heads and upstream of the pump. The system may include a check valve between the scavenging material and the filter heads to reduce a likelihood of contamination of the filter heads with the scavenging material. The scavenging material may be located at an elevation above the filter heads.

In still other embodiments, the system includes a de-bubbling subsystem to purge gas from the system. The de-bubbling subsystem may include a check valve in fluidic communication with the system downstream of the filter heads and upstream of the pump. The de-bubbling subsystem may vent at an elevation above the filter heads. In yet other embodiments, the system may include a priming valve to facilitate filling the system with processed fluid prior to deployment. The priming valve may be in fluidic communication with the system proximate a lowermost elevation. The processed fluid may include distilled water or filtered seawater.

In another aspect, the invention relates to a method of collecting a particle sample from a marine fluid using an in situ system. The method includes inducing flow of ambient marine fluid through a first filter head and a second filter head using a pump disposed downstream of the filter heads, measuring volumetric flow through each filter head, and measuring volumetric flow through the pump.

In accordance with one embodiment of the foregoing aspect, the method includes arranging the filter heads in parallel flow paths. The filter head flow measuring step may include measuring volumetric flow through solely the first filter head and measuring volumetric flow through solely the second filter head. The method may include the step of combining volumetric flows from the first filter head and the second filter head and passing the combined volumetric flow through the pump. The method may include comparing respective volumetric flows through the first filter head, the second filter head, and the pump to assess leakage in the system. The method may include comparing a sum of the first filter head volumetric flow and the second filter head volumetric flow with the pump volumetric flow, whereby substantial equivalence is indicative of insubstantial leakage in the system.

In other embodiments, the method includes the steps of installing filters in the filter heads, deploying the system in the marine fluid at a zone of interest prior to inducing flow, collecting the particle sample on the filters, terminating flow through the filter heads, and retrieving the system. The filters may be adapted to filter at least one of organic material and trace metals from the marine fluid. The method may include scavenging dissolved radionuclides from the marine fluid. The scavenging step may include contacting the marine fluid in the system with MnO₂ and/or CuFeCN. The dissolved radionuclides may be Ra isotopes, Th isotopes, Ac isotopes and/or Cs isotopes. The scavenging step may occur at a location downstream of the filter heads and upstream of the pump to reduce a likelihood of contamination of the filter heads with scavenging material, by preventing reverse flow in the system. The scavenging step may occur at an elevation above the filter heads. In some embodiments, the method includes the step of purging gas from the system. The purging step may include venting gas at an elevation above the filter heads. The method may include the step of priming the system with processed fluid prior to deployment. The processed fluid may include distilled water or filtered seawater.

In still other embodiments, the method includes the step of providing at least one of the filter heads as a subassembly adapted to be removed from the system without disassembly, the subassembly including a top plate including a plurality of baffle tubes and a base plate. The method may include releasably coupling the top plate to the base plate to install and remove a filter therebetween, and may include supporting a filter on the base plate with a perforated element and/or a porous frit element. The subassembly may include at least one baffle plate disposed between the top plate and the base plate above the filter. The baffle plate may include a grate. The method may also include the step of sealing a flow path formed by the top plate and the base plate, for example with an O ring. The method may include covering open ends of the baffle tubes with a perforated film.

### BRIEF DESCRIPTION OF THE FIGURES

Other features and advantages of the present invention, as well as the invention itself, can be more fully understood from the following description of the various embodiments, when read together with the accompanying drawings, in which:

FIG. 1A is a schematic diagram of a marine sample collection system, in accordance with one embodiment of the invention;

FIG. 1B is a schematic diagram of a marine sample collection system, in accordance with another embodiment of the invention;

FIG. 2 is a front photo of the marine sample collection system of FIG. 1B;

FIG. 3A is a schematic exploded side view of a filter subassembly, in accordance with one embodiment of the invention;

FIG. 3B is a schematic top plan view of a top plate of the filter subassembly of FIG. 3A;

FIG. 3C is a schematic top plan view of a grate of the filter subassembly of FIG. 3A;

FIG. 3D is a schematic top plan view of a baffle plate of the filter subassembly of FIG. 3A;

FIG. 3E is a schematic top plan view of a base plate of the filter subassembly of FIG. 3A; and

FIGS. 4A-4D are front perspective photos of the filter subassembly of FIG. 3A in various stages of assembly.

### DETAILED DESCRIPTION OF THE INVENTION

The invention may be better understood by reference to the following detailed description, taken in conjunction with the figures. Various embodiments of the invention relate to a system for analyzing marine parameters. Other configurations and variants will be apparent to those skilled in the art from the teachings herein. Certain aspects of one system are described in “Getting good particles: Accurate sampling of particles by large volume in-situ filtration” by Bisoh, Lam and Wood, published in Limnology and Oceanography: Methods, Vol. 10 (Sept. 2012; pages 681-710), the entirety of which is hereby incorporated herein by reference.

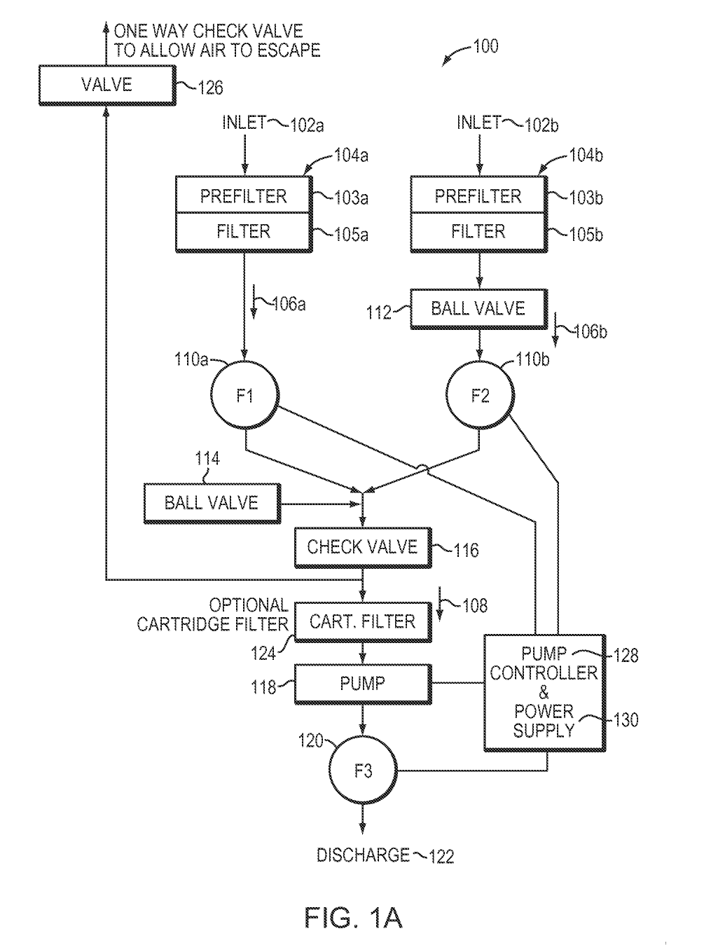

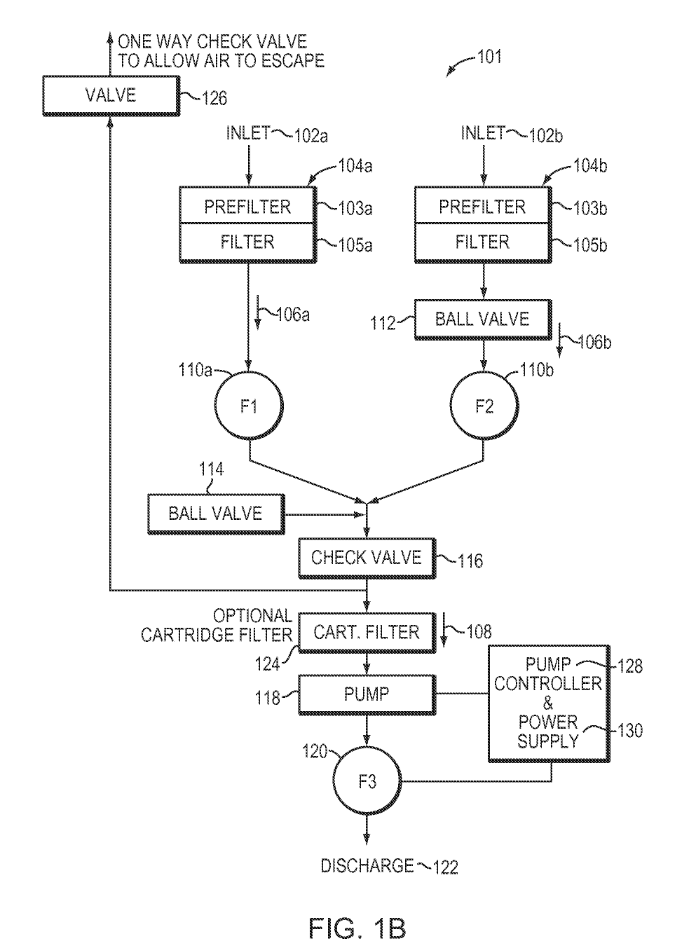

A flow schematic of a marine sample collection system 100 is depicted in FIG. 1. The marine sample collection system 100 includes a first inlet 102a with a first filter head 104a and a second inlet 102b with a second filter head 102b. The filter heads 104a, 104b may each have a screen 103a, 103b and a filter head subassembly 105a, 105b, and are capable of filtering material of interest from ambient marine fluid passing therethrough, such as organic material and/or trace metals. The device and methods described in the specification are also applicable to freshwater, and the term “freshwater” may be substituted wherever the term “marine fluid” is used. The structure of the filter heads 104a, 104b, particularly the filter head subassemblies 105a, 105b, is described in greater detail below. The first filter head 104a and the second filter head 104b may be disposed in separate flow paths 106a, 106b that join together downstream of the filter heads 104a, 104b to form a downstream flow path 108. The flow paths 106a, 106b, and the components therein, may be substantially parallel to each other before joining together. In some embodiments, there may be more than two parallel flow paths. The flow paths 106a, 106b may contain substantially similar components, e.g., similar filter heads 104a, 104b, or the components may be different. Respective filter flow meters 110a, 110b may be disposed downstream of the filter heads 104a, 104b and within the related flow paths 106a, 106b to measure volumetric flow through each filter head 104a, 104b. These filter flow meters 110a, 110b may be configured such that the first filter flow meter 110a measures volumetric flow solely through the first filter head 104a, while the second filter flow meter 110b measures volumetric flow solely through the second filter head 104b. Alternatively, one flow meter may measure flow through one filter head and the second flow meter can measure the combined flow through both filter heads.

A valve 112, such as a ball valve, may be disposed in at least one of the flow paths 106a, 106b (e.g., the second flow path 106b) to restrict flow through the filter head 104a, 104b of least resistance to balance flows between the flow paths 106a, 106b, or even to completely shutoff one flow path 106a, 106b to allow for operation in a single filter configuration. In other embodiments, each flow path 106a, 106b may include a separate valve 112.

The flow paths 106a, 106b may merge into the single, downstream flow path 108 downstream of the flow meters 110a, 110b. The downstream flow path 108 may include a priming valve 114 (e.g., a ball valve) to facilitate filling the system 100 with processed fluid (e.g., distilled water or filtered seawater) prior to deployment. To most effectively function, the priming valve 114 may be disposed at a lower elevation than the other components in the system 100 while remaining in fluid communication with the system 100. The downstream flow path 108 may also include another valve 116, such as a check valve, to prevent the back flow of fluid from the downstream flow path 108 into the upstream flow paths 106a, 106b. A pump 118 is disposed within the system 100, such as within the downstream flow path 108, to induce flow through the filter heads 104a, 104b. An outlet flow meter 120 is disposed downstream of the pump 118 and is used to measure volumetric flow through the pump 118, prior to the flow exiting through an outlet 122. When the flows from the upper flow paths 106a, 106b combine into a single, combined volumetric flow, the combined flow ideally represents the flow that passed through the first filter head 104a and the flow that passed through the second filter head 104b. This combined flow then passes through the pump 118 and the outlet flow meter 120.

In certain embodiments, the system 100 may also include a cartridge filter 124, sometimes disposed downstream of the filter heads 104a, 104b and upstream of the pump 118. The cartridge filter 124 may serve a different function than the filter heads 104a, 104b, such as by containing a material for scavenging dissolved radionuclides from the flow. This scavenging material may be selected for a predetermined application. For example, a scavenging material of MnO₂ and/or CuFeCN may be used for scavenging certain dissolved radionuclides, such as Ra isotopes, Th isotopes, Ac isotopes and/or Cs isotopes. To address contamination concerns often associated with the use of certain scavenging materials, the cartridge filter 124 containing the scavenging material may be located at an elevation above the filter heads 104a, 104b. Placement of the check valve 116 between the scavenging material and the filter heads 104a, 104b also helps to prevent contamination by restricting backflow from the scavenging material to the filter heads 104a, 104b.

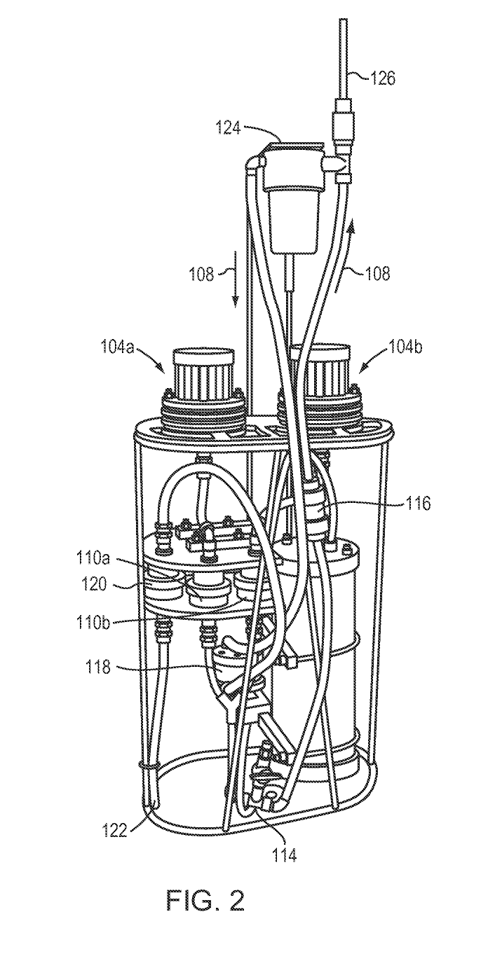

An air release or check valve 126 may be included to allow excess air to escape the system 100, functioning as a de-bubbling system to purge gas from the system 100. The check valve 126 may be located downstream of the filter heads 104a, 104b but upstream of the pump 118. The de-bubbling system may vent the excess gas at an elevation above the filter heads 104a, 104b to minimize impact from the venting on the sample collection. Many of these components, and the elevational relationships between them, may be seen in the depiction of the system 100 in FIG. 2.

A controller 128 may be used to control or monitor various components of the system 100, such as the flow meters 110a, 110b, 120 and the pump 118. In certain embodiments, the controller 128 may control other components of the system 100, such as the valves 112, 114 to operate the system 100 (e.g., controlling flow therethrough or selectively priming). A power supply 130 may be used to power various components, e.g., through the controller 128. The controller 128 may compare outputs of the flow meters 110a, 110b, 120 to determine if there is leakage in the system. If the sum of the output from the first filter flow meter 110a and the second filter flow meter 110b is substantially equivalent to the output from the outlet flow meter 120, then there is likely insubstantial leakage in the system 100. However, a significant difference may indicate a leakage between the filter flow meters 110a, 110b and the outlet flow meter 120. Any leakages in the system 100 may result in overestimating actual volume filtered and thus underestimating concentrations of desired analytes.

FIG. 1B depicts another embodiment of a marine sample collection system 101. The system 101 is substantially the same as the system 100, but the controller 128 is not electrically connected to the flow meters 110a, 110b, 120. The flow meters 110a, 110b, and 120 may have displays (e.g., mechanical or digital displays) for indicating the flow therethrough, such as on the V110 Meter from Elster (Essen, Germany). A user may read the displays and manually compare the values from the displays to determine if there is a leakage in the system 101. Additionally, the valves 112, 114, 116, and 126 may be mechanical, as well. A user may adjust and prime the system 101 manually via these components.

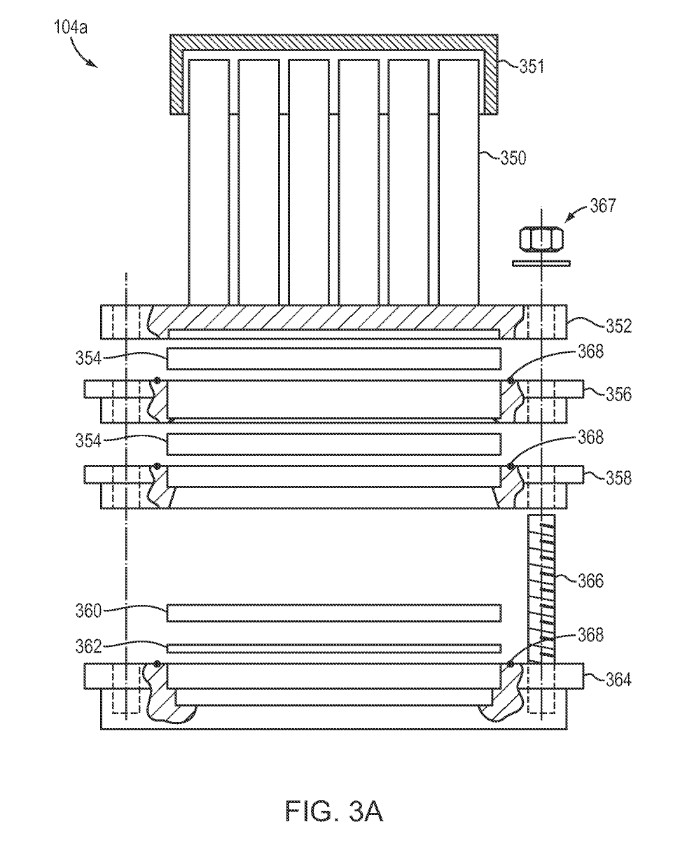

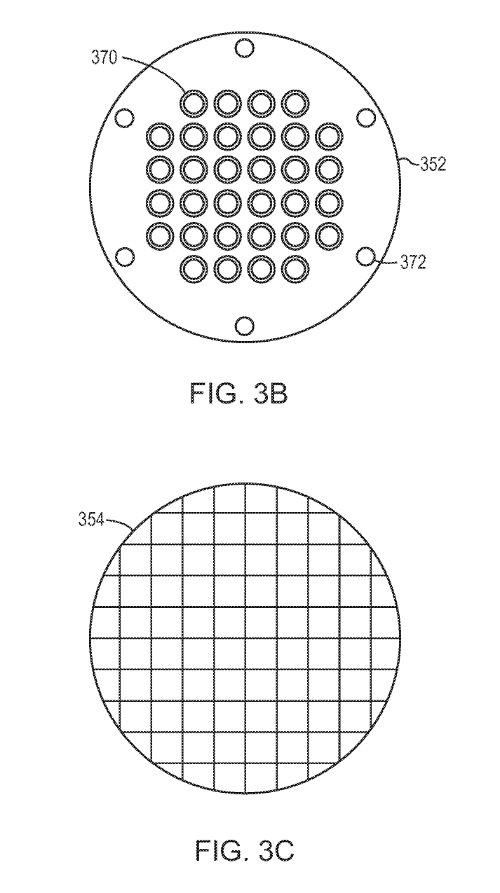

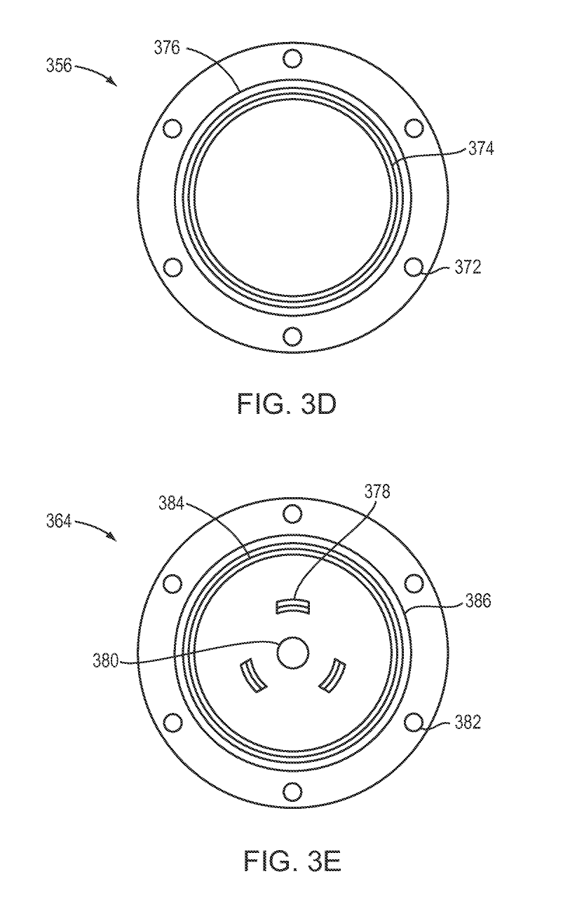

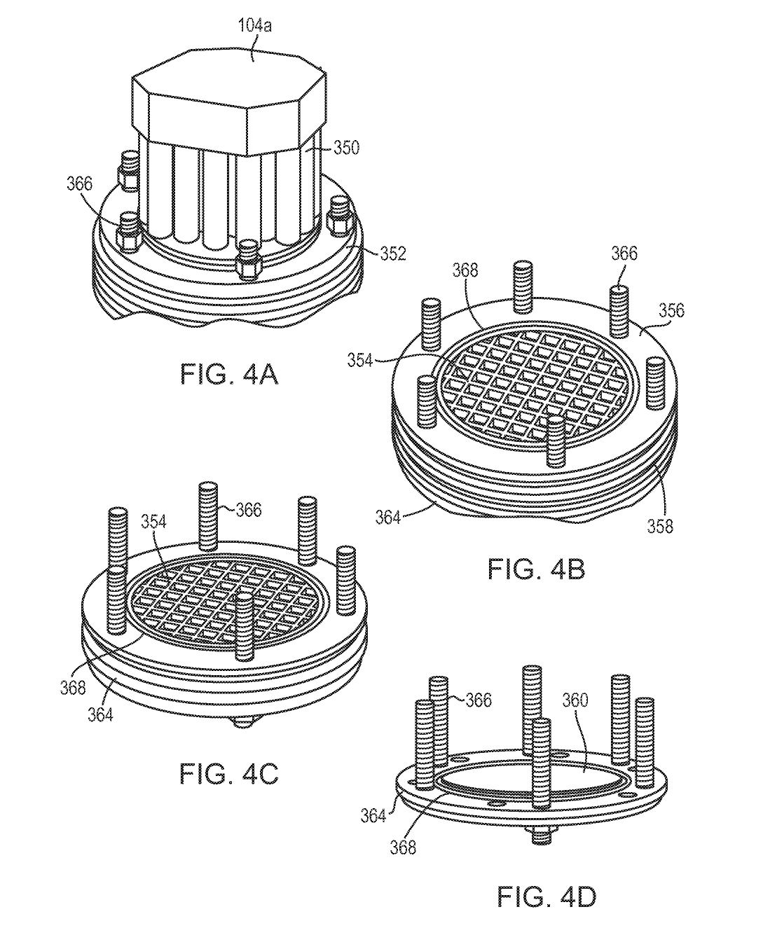

FIG. 3A depicts an exploded side view of the first filter head 104a adapted for use in the system 100. The filter head 104a includes a plurality of baffle tubes 350 disposed on a top plate 352 (FIG. 3B) and grates 354 (FIG. 3C) on either side of a baffle plate 356 (FIG. 3D). Open ends of the baffle tubes 350 may be covered by a perforated film 351. The perforated film 351 may be held in place with an adhesive (e.g., electrical tape). The filter head 104a also includes a prefilter support plate 358 below the lower grate 354, with a porous frit element 360, a perforated element 362, and a base plate 364 (FIG. 3E) below the prefilter support plate 358. The filter head 104a may be releasably coupled together with fasteners (e.g., threaded rods 366 with nuts and washers 367 or wingnuts) extending through the layers, especially from the top plate 352 to the base plate 364, allowing the installation and removal of the layers in between, including filters, such as may be located between the base plate 364 and the prefilter support plate 358. The filter head 104a may include seals for sealing a flow path formed between the top plate 352 and the base plate 364, such as O rings 368 disposed between the adjacent plate layers (i.e., the top plate 352, the baffle plate 356, the prefilter support plate 358, and the base plate 364). FIGS. 4A-4D depict the filter head 104a in various stages of assembly.

The filter head 104a may be removed from the system 100 as a subassembly, without substantially disassembling the system. This facilitates removal and replacement of filter media. The top plate 352, as depicted in FIG. 3B, may include a plurality of recesses 370 sized to receive and retain the baffle tubes 350. There may be any number of recesses 370, including the depicted 32, which may be arranged randomly or in a pattern. The baffle tubes 350 promote laminar flow and help prevent particle loss from the filter upon recovery of the system 100 and removal of the filter head 104a. These tubes 350 may be approximately 4 inches in length with a ½ inch inner diameter. Through holes 372 disposed proximate the perimeter of the top plate 352 are adapted to receive the threaded rods 366. The top plate 352 may be any of a number of sizes, including approximately 7 inches in diameter, though larger and smaller sizes are contemplated to accommodate commercially available or custom filter media disks.

The grate 354 depicted in FIG. 3C includes a grid-like pattern which provides structural rigidity, while still allowing substantially unrestricted flow to pass through the filter head 104a unimpeded. The grate 354 also helps deliver quiescent flow near the surface of the filter, such as within 1/16 inch of the prefilter on the prefilter support plate 358. The prefilters may include a 142 mm diameter mesh prefilter with 51 μm openings or any other sized openings, depending on the particular application. The grates 354 may be smaller than the plates 352, 356, 358, 364 so the grates 354 fit within the sealed flowpath defined by the O rings 368. For example, the grates 354 may be approximately 5 inches in diameter.

The baffle plate 356 depicted in FIG. 3D may include a ledge 374 for receiving and supporting the upper grate 354. The baffle plate 356 may also include a circumferential groove 376 for receiving the O ring 368 and the through holes 372 for accommodating the threaded rods 366. The baffle plate 356 may be generally the same size or slightly larger than the top plate 352, for example having a diameter of approximately 7½ inches. The prefilter support plate 358 may be substantially similar to baffle plate 356, though the cavities formed in the prefilter support plate 358 may have differently sized recesses to accommodate the layers above and below it. For example, in one embodiment, the prefilter support plate 358 must have a cavity whose depth is exactly the thickness of the grate 354 so that the surface of the grate sits flush with the surface of the prefilter support plate. In this embodiment, the baffle plate 356 has a deeper cavity than the prefilter support plate so that the bottom of the grate 354 on the baffle support plate 356 sits 1/16 of an inch above the prefilter.

FIG. 3E depicts the base plate 364. The base plate 364 may include a ledge 384 to support the porous frit element 360 and the perforated element 362, along with integral spacers 378. The frit element 360 and the perforated element 362 may support a small pore-size filter and help ensure even collected particle distribution on the filter. The base plate 364 may also include a circumferential groove 386 to receive the O ring 368 and a hole 380 through which flow may exit the filter head 104a. Threaded holes 382 may be included proximate the perimeter of the base plate 364 to receive ends of the threaded rods 366. The base plate 364 may be sized similarly to the baffle plate 356 and prefilter support plate 358 to provide a substantially uniform appearance.

Various materials may be used for the components of the filter head 104a. All of the materials may be suitable for use in an environment where they are immersed in marine fluid. An all-plastic construction is appropriate for trace metal applications. For example, the baffle tubes 350 and plate 352 may be acrylic, and plates 356, 358, and 364 may be PVC, while the threaded rods 368 and nuts 367 may be acetal plastic. The porous frit element 360 may be made of polyethylene and the perforated element 362 may be made of PVC. O-rings may be made of silicone rubber. The baffles 354 may be made of styrene. PVC, acrylic, and styrene parts can be cleaned by weak acid-leaching, to prevent contamination when used for trace metal applications.

In operation, the system 100 may be prepared on the deck of a ship by installing filters in the filter heads 104a, 104b and priming the system 100 with a processed fluid, such as distilled water or filtered seawater. Once readied, the system 100 may be deployed overboard in a marine fluid at a zone (e.g., depth) of interest prior to inducing flow by turning on the pump 118. The system 100 collects particle samples from the marine fluid in situ, by using the pump 118 to induce flow through separate but parallel flow paths 106a, 106b containing the filter heads 104a, 104b respectively. Particle samples build up on the filters within the filter heads 104a, 104b while fluid is flowing. Flow meters 110a, 110b, one associated with each flow path 106a, 106b, measure the volumetric flow through each filter head 104a, 104b. The flows through the flow paths 106a, 106b combine and may pass through the check valve 116 that prevents back flow in the system 100. This, along with placement of the cartridge 124 above the level of the filters 104a, 104b, is particularly useful in reducing a likelihood of contamination of the filter heads 104a, 104b when scavenging material is used in the optional cartridge filter 124 to scavenge dissolved radionuclides from the marine fluid. The combined flow then proceeds through the pump 118 and the outlet flow meter 120. A controller 128 may compare the outputs of the flow meters 110a, 110b, 120 to determine if there is leakage in the system 100, e.g., by comparing the sum of the output of the first and second flow meters 110a, 110b with the output of the outlet flow meter 120. Alternatively, a user may manually compare the outputs of the flow meters 110a, 110b, 120 (e.g., through a mechanical or digital display on the flow meters 110a, 110b, 120). If these amounts are substantially equivalent, then there is likely insubstantial leakage in the system 100. The system 100 may be optimized by purging gas (i.e., trapped air bubbles in the flow paths and system components) through the use of the check valve 126, thereby venting trapped air bubbles at an elevation above the filter heads 104a, 104b. Placement of the optional cartridge filter 124 containing MnO₂ coating above the filter heads 104a,b and immediately below the check valve 116 allows for venting of the Mn-containing effluent that results from the flooding of the plumbing system upon pump submersion above the filter heads and away from the filter samples. Once the samples have been collected, the pump 118 may be deactivated to terminate flow through the filter heads 104a, 104b and the system 100 retrieved.

Various embodiments and features of the present invention have been described in detail with particularity. The utilities thereof can be appreciated by those skilled in the art. It should be emphasized that the above-described embodiments of the present invention merely describe certain examples implementing the invention, including the best mode, in order to set forth a clear understanding of the principles of the invention. Numerous changes, variations, and modifications can be made to the embodiments described herein and the underlying concepts, without departing from the spirit and scope of the principles of the invention. For example, a third flow path and/or a second Mn-coated cartridge may be included. All such variations and modifications are intended to be included within the scope of the present invention, as set forth herein. The scope of the present invention is to be defined by the claims, rather than limited by the forgoing description of various preferred and alternative embodiments. Accordingly, what is desired to be secured by Letters Patent is the invention as defined and differentiated in the claims, and all equivalents.

What is claimed is:

1. A marine sample collection system adapted for in situ use, the system comprising:
a first filter head and a second filter head for filtering material of interest from ambient marine fluid passing therethrough;
a respective filter flow meter disposed downstream of each of the filter heads for measuring volumetric flow through each filter head;
a pump downstream of the filter heads for inducing flow through the filter heads; and
an outlet flow meter disposed downstream of the pump for measuring volumetric flow through the pump.

2. The system of claim 1, wherein at least one of the filter heads comprises a subassembly adapted to be removed from the system without disassembly.

3. The system of claim 2, wherein the subassembly comprises:
a top plate comprising a plurality of baffle tubes;
a base plate; and
means for releasably coupling the top plate to the base plate to install and remove a filter therebetween.

4.-9. (canceled)

10. The system of claim 1, wherein the filter heads are arranged in parallel flow paths.

11. The system of claim 1, wherein a first filter flow meter measures volumetric flow through solely the first filter head and a second filter flow meter measures volumetric flow through solely the second filter head.

12. The system of claim 11, wherein combined volumetric flows through the first filter head and the second filter head pass through the pump and the outlet flow meter.

13. The system of claim 12, further comprising a controller for comparing respective outputs of the first filter flow meter, the second filter flow meter, and the outlet flow meter to assess leakage in the system.

14. The system of claim 13, wherein a sum of the first filter flow meter output and the second filter flow meter output being substantially equivalent to the outlet flow meter output is indicative of insubstantial leakage in the system.

15. The system of claim 1, wherein the filter heads are adapted to filter at least one of organic material and trace metals.

16. The system of claim 1, further comprising a material for scavenging dissolved radionuclides.

17.-21. (canceled)

22. The system of claim 1, further comprising a de-bubbling subsystem to purge at least one of gas and any excess scavenging material from the system when the pump system is submerged.

23. The system of claim 22, wherein the de-bubbling subsystem comprises a check valve in fluidic communication with the system downstream of the filter heads and upstream of the pump.

24. The system of claim 22, wherein the de-bubbling subsystem vents at an elevation above the filter heads.

25. The system of claim 1, further comprising a priming valve to facilitate filling the system with processed fluid prior to deployment.

26. (canceled)

27. (canceled)

28. A method of collecting a particle sample from a marine fluid using an in situ system, the method comprising the steps of:
inducing flow of ambient marine fluid through a first filter head and a second filter head using a pump disposed downstream of the filter heads;
measuring volumetric flow through each filter head; and
measuring volumetric flow through the pump.

29. The method of claim 28, further comprising the step of arranging the filter heads in parallel flow paths.

30. The method of claim 28, wherein the filter head flow measuring step comprises the steps of:
measuring volumetric flow through solely the first filter head; and
measuring volumetric flow through solely the second filter head.

31. The method of claim 30, further comprising the steps of:
combining volumetric flows from the first filter head and the second filter head; and
passing the combined volumetric flow through the pump.

32. The method of claim 31, further comprising the step of comparing respective volumetric flows through the first filter head, the second filter head, and the pump to assess leakage in the system.

33. The method of claim 32, further comprising the step of comparing a sum of the first filter head volumetric flow and the second filter head volumetric flow with the pump volumetric flow, whereby substantial equivalence is indicative of insubstantial leakage in the system.

34.-53. (canceled)
